(19) United States
(12) Patent Application Publication
(10) Pub. No.: US 2025/0162622 A1
(43) Pub. Date: May 22, 2025

(54) CABLE GUIDE ASSEMBLY AND VEHICLE HAVING THE CABLE GUIDE ASSEMBLY

(71) Applicant: BIZLINK INDUSTRY GERMANY GMBH, Roth (DE)

(72) Inventors: PHILIPP KNAUER, Lisberg (DE); ROBERT MARR, Nuernberg (DE); DANIEL BERGEMANN, Erlangen (DE)

(21) Appl. No.: 18/707,984

(22) PCT Filed: Oct. 4, 2022
(86) PCT No.: PCT/EP2022/077544

§ 371 Date: May 7, 2024

(30) Foreign Application Priority Data
Nov. 9, 2021 (DE) 10 2021 129 051.1

(51) Int. Cl. B61G 5/10; B61G 5/08

(52) U.S. Cl. CPC B61G 5/10; B61G 5/08

(57) ABSTRACT

A cable guide assembly for a rail vehicle for guiding at least one cable from a first vehicle part to a second vehicle part coupled to the first vehicle part includes a first stabilization device mounted on the first vehicle part and the at least one cable. The first stabilization part is deformable in a first guiding duration and rigid perpendicular thereto. The first stabilization part is coupled to a first cable section of the cable such that the deformability of the first stabilization device permits movement of the first cable section in the first guiding direction and blocks movement perpendicular thereto.

### RELATED APPLICATIONS

This application filed under 35 U.S.C § 371 is a national phase application of International Application Number PCT/EP2022/077544, filed Oct. 4, 2022, which claims the benefit of German Application No. 10 2021 129 051.1 filed Nov. 9, 2021, the subject matter of which are incorporated herein by reference in their entirety.

### TECHNICAL FIELD

The present invention relates to a cable guide assembly for a vehicle for guiding at least one cable from a first vehicle part to a second vehicle part, which is coupled in an articulated manner to the first vehicle part, as well as to a vehicle having such a cable guide assembly.

### BACKGROUND

Cables are required in vehicles to transport a medium, for example, between different parts of the vehicle or to create an electrical connection between parts of the vehicle. If the vehicle consists of two vehicle parts connected in an articulated manner to one another, such as is the case with rail vehicles, for example, a cable or a plurality of cables must regularly be provided that connect the vehicle parts to one another. On account of the articulated linkage and the resultant movement of the vehicle parts relative to one another, a cable which connects the vehicle parts to one another must likewise permit the relative movements of the vehicle parts to one another and withstand the resultant stress.

To achieve this, according to a known approach the cable is laid in a loop shape or in suspension tracks between the vehicle parts, so that ultimately the cable between the vehicle parts is designed to be longer than would be necessary for a direct connection of the vehicle parts. In this solution, the cable is usually attached in an upper region of the vehicle parts and hangs downwards due to gravity in a loop shape or in suspension tracks. This requires a free space between the vehicle parts, however, which must also be formed comparatively large. This free installation space is not always structurally present, however.

To keep the required free space between the vehicle parts smaller, cables which have a spiral shape or helical shape are used according to another known approach at least in the region between the vehicle parts. Even then, however, the cables can sag in the direction of gravity. In addition, loads on the vehicle parts or fatigue of the cables can lead to lengthening of the cables occurring and the required free space nevertheless having to be kept large. A configuration as a spiral or helical form is also not possible for all cables. Think of large diameters, material and temperature of the cables or of a medium carried.

According to another known approach, cables are supported in a region between the vehicle parts by a stabilisation device, for example. Stabilisation devices are known in this case which extend continuously from one vehicle part to the other vehicle part. Further add-on elements can be provided to link the stabilisation device to the vehicle parts. A stabilisation device of this kind is known, for example, from DE 10 2016 201 437 A1 or DE 10 2010 011 903 B4.

Since a stabilisation device must withstand movements with up to six degrees of freedom, large loads can arise on the stabilisation device. Furthermore, large loads can arise due to a large movement between the vehicle parts. This can occur, for example, on tight curves through which the vehicle parts travel.

A large load can lead to rapid wear of the cables, portions of the vehicle parts or of the stabilisation device.

Environmental influences such as temperature variations, water, ice, soiling etc., must also be taken into account overall which cause increased wear and a short lifespan especially in the case of costly and complex solutions for stabilisation devices.

Another cable guide is known from EP 3 067 245 A1, in which large loads are to be avoided in that a cable is movable back and forth on a respective vehicle part in a track between sides of the vehicle. Such mobility by means of tracks is not possible for all cables, however. Furthermore, additional installation space that permits movement of the cables along the tracks must be provided or blocked on the vehicle parts.

To reduce the loads of the cables to an acceptable level, the mobility of the vehicle parts relative to one another can also be restricted. This is not possible, however, for all vehicle types or operational purposes.

A requirement thus exists to guide cables between vehicle parts in such a way that only a small free space is needed between the vehicle parts. Furthermore, the freedom of movement of the vehicle parts relative to one another is not to be restricted or is to be restricted only slightly. The load on the cables is also to be kept small.

The object of the present invention is to provide a cable guide assembly and a vehicle of the type described at the beginning that solve at least one of the aforesaid problems.

### SUMMARY

This object is achieved by a cable guide assembly for a vehicle, in particular a rail vehicle, for guiding at least one cable from a first vehicle part to a second vehicle part, which is coupled to the first vehicle part in an articulated manner. The cable guide assembly has a first stabilisation device, which can be mounted on the first vehicle part, and the at least one cable. The first stabilisation device is deformable in a first guiding direction and is formed rigid perpendicular to this. The first stabilisation device is coupled to a first cable section of the cable in such a way that the deformability of the first stabilisation device permits a movement of the first cable section in the first guiding direction and blocks it perpendicular thereto.

A cable guide assembly can thus be provided that requires a small free space between a first vehicle part and a second vehicle part. Furthermore, a cable guide assembly can thereby be provided that requires little free space in a certain direction, for example in the direction of gravity. This is achieved in that the stabilisation device is formed rigid perpendicular to the guiding direction. Thus a force of the cable perpendicular to the guiding direction—for example, due to the action of gravity—leads to no or almost no deflection of the stabilisation device. If a force of the cable acts in the guiding direction, however—for example, a force resulting from the movement of the vehicle parts relative to one another—, this force can cause a deformation of the stabilisation device. It is thereby possible for the cable guide assembly to adapt to movements of the vehicle, in particular of the vehicle parts. The cable is thus reliably guided between vehicle parts with a small installation space at the same time.

The cable guide assembly further enables great freedom of movement. The stabilisation device can execute a large deflection in the respective guiding direction or about a rotation axis perpendicular thereto. In this case only a small load acts on the cable or cables.

According to a development of the invention, it can be provided that the first stabilisation device is formed to be elastically deformable in the first guiding direction. This facilitates a deformability in which a reset force acts into a neutral position of the stabilisation device. Furthermore, the deformation is thus reversible.

According to an aspect of the invention, it can be provided that the first stabilisation device has at least one stabilisation element, which determines the deformability of the stabilisation device. It is thereby possible to design the stabilisation element and its properties specifically, for example with respect to its preferably elastic deformability, based on certain requirements. The properties of the cable guide assembly can thus be influenced specifically by means of the stabilisation element.

According to a development of the invention, it can be provided that the stabilisation element has a substantially rectangular cross section. Here the longer edge of the rectangular cross section can be arranged perpendicular to the first or second guiding direction. The longer edge of the rectangular cross section can thus predefine the rigid property of the stabilisation element. At the same time, on account of the shorter edge, the stabilisation element can be deformable in the direction of the shorter edge. The properties of the stabilisation element can be adapted in a simple manner by changing the ratio of shorter to longer edge of the rectangular cross section or the material thickness in a respective edge direction.

According to a configuration of the invention, the stabilisation element can comprise steel, in particular spring steel, plastic, a composite material, in particular carbon-fibre-reinforced plastic, or a combination thereof. Steel is a versatile and adaptable material, which is also resilient. Spring steel can enable an especially high ratio of yield strength to tensile strength of the material. This ratio can usually lie in a range greater than 85%. The spring steel can thus be strongly elastically deformed, which favours use of the cable guide assembly in large movements of connected vehicle parts relative to one another. Furthermore, a high service life can be achieved. Plastics have the advantage of low weight, wherein composite materials additionally have particularly high strengths in at least one load direction.

According to an aspect of the invention, it can be provided that the first stabilisation device has a base element, which is provided to be connected fixedly to the vehicle part. The cable guide assembly can thus be adapted to different connection options to vehicle parts by adaptation of the base element. The base element can further transmit a movement of a connected vehicle part to the pertinent stabilisation device. Due to the fact that the cable is guided in the cable guide assembly and the stabilisation device, a load can be removed from the cable.

According to a development of the invention, it can be provided that the first stabilisation device has a guide element, which is attached by means of the stabilisation element to the base element. The guide element can thereby be moved freely with the cable in the respective guiding direction.

An aspect of the invention can provide that the first cable section is arranged between the base element and the guide element of the first stabilisation device. The first cable section can thus be guided by the associated base element and guide element in the respective guiding direction.

A configuration of the invention can provide that the first stabilisation device has at least one holding element, which supports the cable in the stabilisation device. The holding element can thus act, for example, as a type of connecting link between the cable and the stabilisation device. If a cable has a certain cross section, it can be sufficient to adapt only the holding element accordingly without having to adapt the stabilisation device. High flexibility can thus be achieved overall.

A development thereof can provide that the holding element connects the cable fixedly to the stabilisation device. This causes the movement of the cable to be coupled to the movement of the stabilisation device in the region of the holding element. Play between the cable and cable guide assembly in the region of the holding element can therefore be avoided.

According to an aspect of the invention, it can be provided that the holding element permits a movement of the cable relative to the stabilisation device in a longitudinal direction of the cable and/or permits a rotation of the cable about a longitudinal direction of the cable relative to the stabilisation device. Moreover, further degrees of freedom can also be facilitated.

It can also be provided according to an aspect of the invention that the holding element enables five degrees of freedom of the cable relative to the first stabilisation device, while the sixth degree of freedom coincides with the direction perpendicular to the associated guiding direction and is blocked.

Moreover, it can be provided according to a configuration of the invention that the first stabilisation device enables five degrees of freedom of the cable relative to the stabilisation device, while the sixth degree of freedom coincides with the direction perpendicular to the associated guiding direction and is blocked. The stabilisation device can therefore block precisely one degree of freedom. A small installation space requirement can thus be achieved in the direction of the blocked degree of freedom. At the same time, freedom of movement of the cable in the other degrees of freedom can be achieved. The cable guide assembly can thus enable a large freedom of movement of vehicle parts coupled to one another. Despite the restricted sixth degree of freedom, a certain degree of movement in the direction of the sixth degree of freedom can nevertheless be facilitated on account of the free cable section between the stabilisation devices, which thus enables movement of the cable in the free cable section upon movement of coupled vehicle parts in the direction of the sixth degree of freedom.

It can be provided in a development of the invention that the holding element permits at least one degree of freedom of the cable relative to the first stabilisation device up to a certain extent. Certain movements of the cable relative to the first stabilisation device can therefore be enabled. Movements going beyond this, however, are linked to the deformability of the stabilisation device or the cable guide assembly as a whole. Tension peaks in the cable can thus be reduced. Furthermore, stressing of the cable and the cable guide assembly can be reduced.

According to a configuration of the invention, it can be provided that the holding element has an interior region that supports the cable, wherein preferably an inner diameter of the interior region increases at least partially in at least one direction along the cable. The interior region can thus be designed in the shape of a trumpet. Kink protection can thereby be achieved for the cable. The cable can be coupled to the holding element in a comparatively small region. Furthermore, a gentle transition can be achieved between a region coupled to the holding element and a region of the cable not coupled to the holding element. Tension peaks on the cable can therefore be reduced or even avoided.

According to a development of the invention, it can be provided that the first stabilisation device has a first such holding element, which supports the cable in its base element, and/or a second such holding element, which supports the cable in its guide element. It can thus be achieved that the cable is supported in the base element and the guide element of one of the stabilisation devices in the cable guide assembly. It can be provided in this case that both holding elements are designed identically. Alternatively, the holding elements can also be designed differently. For example, a holding element that fixedly supports the cable can be selected for the base element, and for the guide element, a holding element that permits movement of the cable relative to the stabilisation device in a longitudinal direction of the cable and/or permits rotation of the cable about a longitudinal direction of the cable relative to the stabilisation device and/or permits another degree of freedom at least up to a certain extent.

It can be provided according to an aspect of the invention that a longitudinal axis of the first cable section is arranged substantially perpendicular to the first guiding direction. In particular, it can then be provided that a holding element is provided which enables at least one degree of freedom of the cable. Movements can be compensated for by the degree of freedom in this way.

According to a development of the invention, it can be provided that a longitudinal axis of the stabilisation element of the first stabilisation device is arranged substantially perpendicular to the first guiding direction.

It can be provided according to an aspect of the invention that the cable is an electric cable or a media hose for guiding a medium, for example a hydraulic hose or a pneumatic hose.

It can further be provided that the cables of the cable guide assembly are of a different type. A first cable can be an electric cable, for example, while a second cable is a pneumatic hose.

It can also be provided that the cables of the cable guide assembly have different dimensions and/or different cross-sectional geometries and/or different materials and/or different elasticities.

It can be provided that at least one of the cables has a round, in particular circular, oval, triangular, quadrangular, preferably rectangular or square, or polygonal cross section.

A development of the invention provides that the first stabilisation device has two, three, four or more stabilisation elements.

According to a configuration of the invention, it can be provided that the first stabilisation device has at least two stabilisation elements, the longitudinal axes of which span a plane that is arranged perpendicular to the guiding direction. This permits a small installation space requirement perpendicular to this plane.

According to an embodiment of the invention, it can be provided that the first stabilisation device has at least two stabilisation elements, the longitudinal axes of which are arranged perpendicular to the associated guiding direction.

According to a configuration of the invention, it can be provided that the cable has a sheath, at least in the region of the first stabilisation device, preferably in the region of the base element and/or guide element, particularly preferably in the region of at least one holding element, which sheath at least partially encloses the cable. Additional protection, which can be kink protection, for example, can thereby be achieved for the cable.

According to a development of the invention, it can be provided that a connection device is formed on the base element of the first stabilisation device. This makes it possible to connect an area of the cable that extends along the cable guide assembly to a cable of the first vehicle part. Simple installation of the cable guide assembly on the vehicle can thus be provided.

According to a development of the invention, it can be provided that the cable guide assembly further comprises a second stabilisation device, which can be mounted on the second vehicle part. The second stabilisation device is deformable in a second guiding direction and formed rigid perpendicular to this. The second stabilisation device is coupled to a second cable section of the cable such that the deformability of the second stabilisation device permits a movement of the second cable section in the second guiding direction and blocks it perpendicular thereto. Due to the second stabilisation device, a cable guide assembly with improved stability and improved guiding properties can be achieved. The connection to vehicle parts can also be made easier.

It is understood that individual features, configurations, advantages and/or properties that are explained in connection with the first stabilisation device or generally for a stabilisation device can find application by analogy for the second stabilisation device, even if this is not explicitly explained. In the following, only some features are cited in connection with the second stabilisation device.

A development of the invention can provide that a free cable section of the cable couples the first and the second stabilisation device to one another. It can thereby be achieved in an advantageous manner that the cable can move freely in the region of the free cable section. This also has the advantage that the cable guide assembly can deform flexibly in the region of the free cable section on account of the properties of the cable and can thus enable large movements. At the same time, small stressing of the stabilisation devices can be achieved as a whole. Loading of the cable in the region of the free cable section can also be avoided, so that wear on the cable can also be avoided. Overall the cable can thus be guided in the respective guiding directions at least partially, wherein in the region of the free cable section, however, even movements perpendicular to the respective guiding directions can be reproduced or permitted. The section modulus of the cable can contribute thereto that in the region of the free cable section, gravity only has a slight effect on the cable or its deformation in the direction of gravity or perpendicular to at least one of the guiding directions.

An aspect of the invention can provide that the second cable section is arranged between the base element and the guide element of the second stabilisation device. The second cable section can therefore be guided by the associated base element and guide element in the respective guiding direction.

According to an aspect of the invention, it can be provided that a longitudinal axis of the second cable section is arranged substantially perpendicular to the second guiding direction.

According to a development of the invention, it can be provided that a longitudinal axis of the stabilisation element of the second stabilisation device is arranged substantially perpendicular to the second guiding direction.

The object according to the invention is also achieved by a vehicle, which has a first vehicle part, a second vehicle part, which is coupled in an articulated manner to the first vehicle part, and at least one cable guide assembly of the type described above. The first stabilisation device is arranged on the first vehicle part. The cable leads from the first vehicle part to the second vehicle part.

Furthermore, the object according to the invention is achieved by a vehicle, which has a first vehicle part, a second vehicle part, which is coupled in an articulated manner to the first vehicle part, and at least one cable guide assembly of the type described above. The first stabilisation device is arranged on the first vehicle part and the second stabilisation device is arranged on the second vehicle part. The cable leads from the first vehicle part to the second vehicle part.

In this way a vehicle is achieved on which one cable or several cables can be guided reliably from the first to the second vehicle part, even if the vehicle parts are coupled to one another in an articulated manner. Due to the cable guide assembly, the vehicle can realise even large movements of the vehicle parts relative to one another. This applies in particular to movements of the vehicle part about a rotation axis perpendicular to the or one of the guiding directions.

At the same time, cables can be guided between vehicle parts on a vehicle that has only little free space between the vehicle parts, in particular in the direction perpendicular to one of the guiding directions.

A vehicle can also be achieved that exerts no load or at least only a small load on the cable between the vehicle parts.

A development of the invention can provide that the vehicle parts are coupled to one another rotatably about a rotation axis and the rotation axis is arranged substantially perpendicular to the first guiding direction and/or second guiding direction. This can apply in particular to a state in which the vehicle parts are located in a neutral position relative to one another and/or are only pivoted about the rotation axis relative to one another. A vehicle can thus be achieved that enables no loading or only slight loading of the cable or cables in the area between the vehicle parts. A rotatable linkage of the vehicle parts can be a so-called Jacob-type bogie or a coupling, but is not limited thereto.

A development of the invention can provide that the first and the second guiding direction in a neutral position of the vehicle parts relative to one another are arranged in a common plane and/or are arranged perpendicular to one another.

A configuration of the invention can provide that the first stabilisation device is arranged in such a way on the first vehicle part and the second stabilisation device is arranged in such a way on the second vehicle part that in a neutral position of the two vehicle parts relative to one another, a longitudinal axis of the first cable section encloses an angle with a longitudinal axis of the second cable section. The angle is preferably in the range of 45 to 135 degrees. Particularly preferably the angle is substantially 90 degrees. It can thus be achieved that the cable guide assembly permits a great freedom of movement of the vehicle parts relative to one another. At the same time, the loading of the cable is small. Furthermore, a vehicle can be achieved that only requires a small installation space between the vehicle parts to guide the cable or the cables from the first vehicle part to the second vehicle part.

According to an aspect of the invention, it can be provided that the first stabilisation device is arranged in such a way on the first vehicle part and the second stabilisation device is arranged in such a way on the second vehicle part that in a neutral position of the two vehicle parts relative to one another, at least one of the stabilisation devices is likewise in a neutral position.

It can further be provided according to a configuration of the invention that a length of the first cable section and/or a length of the second cable section is smaller than a length of the free cable section. The length of the free cable section can be more than twice as great as the length of the first cable section and/or second cable section.

It should be noted that in cases in which only one cable of the cable guide assembly is mentioned, the statements, features and/or configurations also apply to the case that several cables are provided in the cable guide assembly. It is understood that if one or more holding elements, for example, are provided for a cable, one or more holding elements can be provided also for another cable of the cable guide assembly.

By the direction perpendicular to the guide plane, a direction can be meant that is also arranged relative to a longitudinal axis of the first and/or second stabilisation element and/or a longitudinal axis of the first and/or second cable section.

Even if details were/are described only in regard to the cable guide assembly, these details can be realised in a corresponding manner in the vehicle with the cable guide assembly. Likewise, details described in regard to the vehicle with the cable guide assembly can be realised in a corresponding manner in the cable guide assembly.

Even if a vehicle is cited or vehicle parts are cited in connection with the cable guide assembly, the invention is not restricted thereto. Vehicle can be replaced by “multipart object”, “first vehicle part” by “first part of the multipart object” and “second vehicle part” by “second part of the multipart object”.

### BRIEF DESCRIPTION OF THE DRAWINGS

The invention is explained below by way of example with the aid of the enclosed figures. There is depicted:

FIG. 1 a schematic representation of a cable guide assembly;

FIG. 2 a section of a top view of a schematic representation of a vehicle with a cable guide assembly;

FIG. 3 a schematic representation of a first assembly of guide elements and cables;

FIG. 4 a schematic representation of a second assembly of guide elements and cables;

FIG. 5 a schematic representation of a third assembly of guide elements and cable;

FIG. 6 a schematic representation of a fourth assembly of guide elements and cable; and

FIG. 7 a schematic representation of a vehicle with a cable guide assembly.

### DETAILED DESCRIPTION

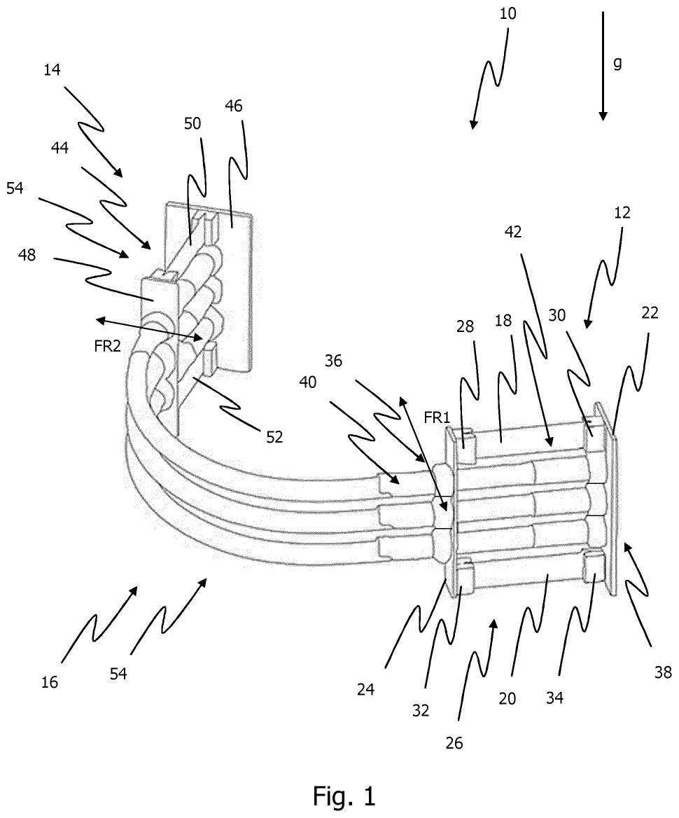

FIG. 1 shows a schematic representation of a cable guide assembly 10. The cable guide assembly has a first stabilisation device 12 and a second stabilisation device 14. The cable guide assembly 10 also has cables 16, which lead from the first stabilisation device 12 to the second stabilisation device 14.

The first stabilisation device 12 has a first and a second stabilisation element 18, 20, which extend starting out from a base element 22 of the first stabilisation device 12 to a guide element 24 of the first stabilisation element 12. The two stabilisation elements 18, 20 have a cross section with a rectangular shape. Furthermore, both stabilisation elements 18, 20 are formed with a substantially constant thickness. The longer side of the cross section of the rectangular shape is arranged perpendicular to the first guiding direction FR1.

The first and the second stabilisation element 18, 20 also each have a longitudinal axis, which are arranged parallel to one another. Furthermore, the longitudinal axes of the first and the second stabilisation element 18, 20 are arranged parallel to respective longitudinal axes of the cables 16 in the first stabilisation device 12.

Located between the base part 22 and the guide part 24 is a first cable section 26 of the cables 16 in each case.

The cables 16 lead with regard to the first stabilisation device 12 from the base element 22 to the guide element 24. Stated more precisely, the cables 16 lead through the base element 22 and the guide element 24 through corresponding openings.

For reasons of simplicity, it is depicted that the cables 16 do not extend beyond the base parts of the respective stabilisation device 12, 14. Here the cables 16 can in fact run also beyond the base parts. In addition or alternatively, respective connections can be formed on the base parts in order to link the cables 16 to cables present on the vehicle parts. It can also be provided here that the base elements are themselves part of a connection.

The stabilisation elements 18, 20 of the first stabilisation device 12 are attached by means of respective brackets 28, 30, 32, 34 to the base element 22 and the guide element 24 of the first stabilisation device 12. The brackets 28, 30, 32, 34 here have clamp jaws, which take up the respective stabilisation element 18, 20 and enable a simple exchange of the stabilisation elements 18, 20.

It is to be gathered further from FIG. 1 that the cables 16 are connected respectively at the guide element 24 of the first stabilisation device 12 via first holding elements 36 to the guide element 24. The cables 16 are also connected respectively at the base element 22 of the first stabilisation device 12 via second holding elements 38 to the base element 224. Here the cables 16 rest by means of the first holding elements 36 fixedly in the guide element 24 and the second holding elements 38 fixedly in the base element 22. The holding elements 36, 38 can also enable individual degrees of freedom of the cables, however, relative to the base element 22 and guide element 24, at least up to a certain extent.

In the region of the first holding elements 36, the cables 26 have first sheaths 40 and in the region of the second holding elements 38, second sheaths 42. The sheaths 40, 42 serve to protect the cables 16. The sheaths 40, 42 can also have a certain stiffness, however, so that kink protection can be achieved by the sheaths. The stiffness can be reduced in at least a defined direction of the sheath. Thus the first sheaths 40, for example, have openings respectively on their underside, which serve to make movement of the respective cable 16 easier in the direction of the underside.

It can be recognised that the first stabilisation device 12 permits a movement of the guide element 24 in the first guiding direction FR1 relative to the base element 22 on account of the structural design as described above. The slight thickness of the two stabilisation elements 18, 20 in the direction of the first guiding direction FR1 contributes to this. By contrast, a movement perpendicular to the first guiding direction FR1 is blocked. The height of the two stabilisation elements 18, 20 in a direction perpendicular to the first guiding direction FR1 contributes to this.

A movement of the cables 16 in the region between the stabilisation devices 12, 14 and the guide element 24 in a direction perpendicular to the guiding direction FR1 can result from the gravitational force g, which acts in FIG. 1 by way of example perpendicular to the first guiding direction FR1. This orientation with respect to gravity applies in particular if the cable guide assembly 10 is mounted on a vehicle that is located on the flat. On gradients of the track, the direction of the gravitational force g and the direction perpendicular to the first guiding direction FR1 can diverge.

The second stabilisation device 14 is constructed by analogy with the first stabilisation device 12. In the following, therefore, not all parts are enlarged upon afresh, but instead only some parts or special aspects of the construction are enlarged upon.

A second cable section 44 of the cables 16 extends between a base element 46 and a guide element 48 of the second stabilisation device 14. A first stabilisation element 50 and a second stabilisation element 52 of the second stabilisation device 14 also extend in the region of the second cable section 44.

The guide element 48 of the second stabilisation device 14 is movable or pivotable on account of the elastic deformability of the second stabilisation device 14 in a second guiding direction FR2 relative to the base element 46 of the second stabilisation device 14. Perpendicular to the second guiding direction FR2, the second guide element 48 is not correspondingly pivotable, but rigid.

With the second stabilisation device 14, in the event of pivoting in the second guiding direction FR2, the second cable section 44 is likewise pivoted in the second guiding direction FR2.

It should be noted that in their pivoting relative to the respective base elements 22, 46, the respective guide elements 24, 48 pivot in a direction resulting from their pivot movement. This direction is termed first or second guiding direction FR1, FR2, regardless of an exact height position of the guiding directions FR1, FR2.

Arranged between the first stabilisation device 12 and the second stabilisation device 14 is a free cable section 54.

The cables 16 thus lead starting from the first stabilisation device 12 from its base element 22 along the first cable section 26 through the guide element 24, along the free cable section 54 to the second stabilisation device 14 through its guide element 48 along the second cable section 44 to the base element 46 and through this.

As is to be gathered from FIG. 1, the cables 16 are bent. A longitudinal axis of the first cable section 26 is thus arranged at an angle to a longitudinal axis of the second cable section 44.

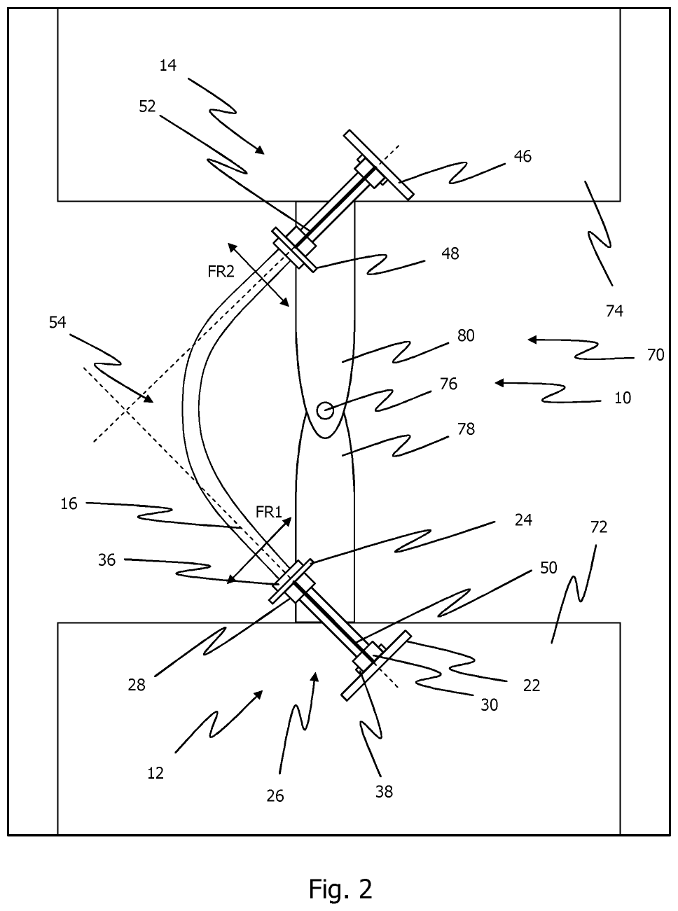

FIG. 2 shows a section of a top view of a schematic representation of a vehicle 70 with a cable guide assembly 10. The vehicle has a first vehicle part 72 and a second vehicle part 74, wherein the first vehicle part 72 is linked to the second vehicle part 74 by way of a link 76. The link 76 connects respective attachment devices 78, 80 of the vehicle parts 72, 74. The link 76 has a rotation axis, which runs in the direction of the image plane. With regard to the two vehicle parts 72, 74, the rotation axis thus runs in a height direction of the vehicle 70. The first stabilisation device 12 is mounted on the first vehicle part 72 and the second stabilisation device 14 is mounted on the second vehicle part 74.

The first stabilisation device 12 is connected fixedly by means of its base element 22 to the first vehicle part 72. The cables 16 are connected to the base element 22 by way of the respective associated first holding elements 38, which are at least partially concealed by the bracket 30 in the representation shown.

The cables 16 extend along the first cable section 26 as far as the guide element 24 of the first stabilisation device 12. The first stabilisation element 18 also extends from the base element 22 to the guide element 24 of the first stabilisation device 12, but is attached by means of the respective brackets 28, 30 to the base element 22 and the guide element 24 of the first stabilisation device 12. The first cable section 26 extends between the base element 22 and the guide element 24.

The cables 16 lie above one another in the present view, so that only the topmost cable is visible.

The guide element 24 of the first stabilisation device 12 is connected to the cables by way of the respective second holding elements 36. Moreover, the guide element 24 is pivotable in the first guiding direction FR1.

Arranged between the first stabilisation device 12 and the second stabilisation device 14 is the free cable section 54. It describes the part of the cables 16 between the stabilisation devices 12, 14.

The second stabilisation device 14 of FIG. 2 is also constructed substantially identically to the first stabilisation device 12. Reference is therefore made to the construction of the first stabilisation device 12.

It is to be gathered from FIG. 2 that in the neutral position of the two vehicle parts 72, 74 relative to one another, a longitudinal axis of the first cable section 26 is arranged at an angle to a longitudinal axis of the second cable section 44, wherein the angle is approximately 90 degrees. As is further to be gathered from FIG. 2, the angle in the neutral position depends on the alignment in which the respective base elements 22, 46 are mounted on the respective vehicle parts 72, 74. With the alignment it can be set how strongly the cables 16 are bent in a relative movement of the vehicle parts 72, 74 to one another.

The distance and the space available between the two vehicle parts 72, 74 is shown by way of example in FIG. 2. The distance between the two vehicle parts 72, 74 could also be much smaller or larger, wherein guiding cables from the first vehicle part 72 to the second vehicle part 74 would nevertheless be possible. The same applies to a smaller or larger space available between the two vehicle parts 72, 74.

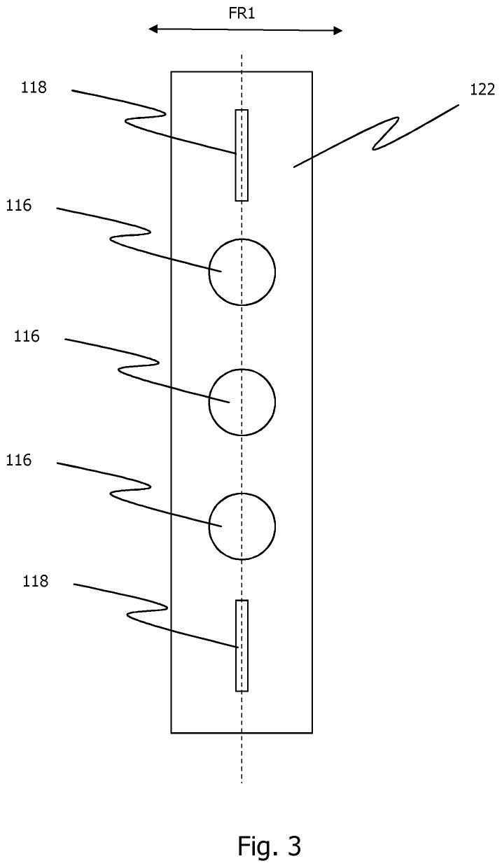

FIG. 3 shows a schematic representation of a first assembly of the stabilisation elements 118 and the cables 116 with regard to the base element 122, wherein of the cables 116 and the stabilisation elements 118, only the cross-sectional shapes are represented schematically and projected onto the base element 122. The centre points of the cross sections of the cables 116 and of the stabilisation elements 118 lie on a common axis. The common axis is arranged centrally with regard to the base element 122. Furthermore, the first guiding direction FR1 is depicted by way of example in order to clarify the direction in which elastic deformation of the first stabilisation device according to the first assembly is permitted. The rigid direction of the stabilisation elements 118 is formed perpendicular to the guiding direction FR1.

Three cables 116 are depicted here, wherein also only one, two, four cables 116 could be provided. Furthermore, even just one stabilisation element could be arranged in particular above or below the cables 116 or one cable.

The first assembly can be advantageous if sufficient installation space perpendicular to the guiding direction FR1 is available on the vehicle 70 or between the vehicle parts 72, 74.

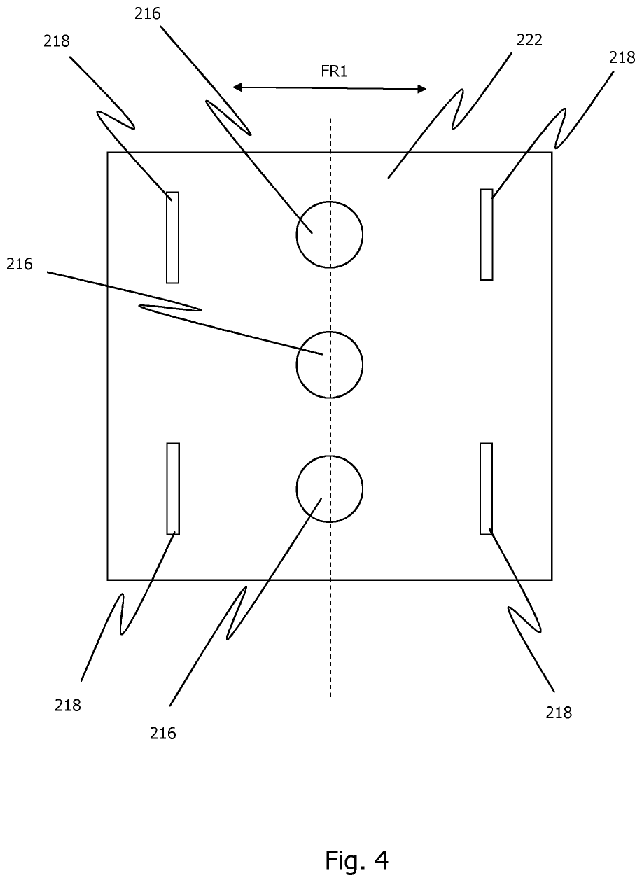

FIG. 4 shows a schematic representation of a second assembly of the stabilisation elements 218 and the cables 216 with regard to the base element 222, wherein of the three cables 216 and the stabilisation elements 218, only the cross-sectional shapes are represented schematically and projected onto the base element 222. The centre points of the cross sections of the cables 216 lie on a common axis. The common axis is arranged centrally with regard to the base element 222. The stabilisation elements 218 are assigned to respective corners of the base element 222.

Three cables 216 are depicted here, wherein also only one, two, four cables 216 could be provided.

Furthermore, the first guiding direction FR1 is depicted by way of example, in order to clarify the direction in which elastic deformation of the first stabilisation device according to the second assembly is permitted. The rigid direction of the stabilisation elements 218 is formed perpendicular to the guiding direction FR1.

The second assembly can be advantageous if particularly high stability of the stabilisation device is necessary.

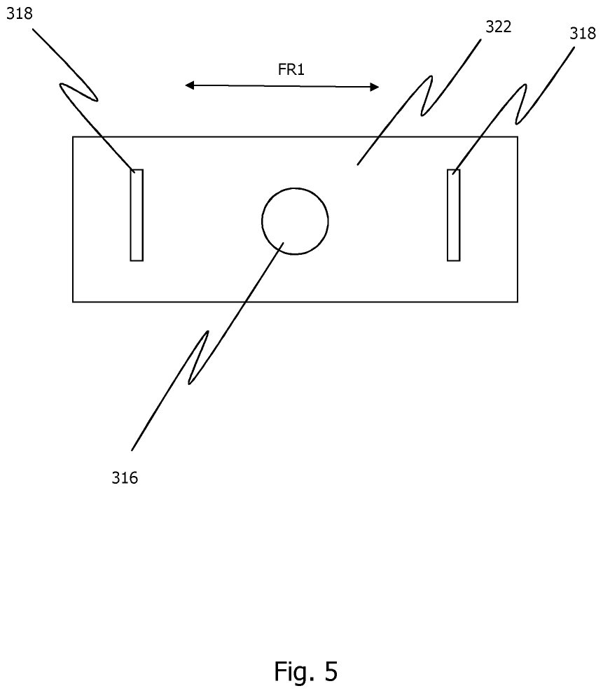

FIG. 5 shows a schematic representation of a third assembly of the stabilisation elements 318 and the cable 316 with regard to the base element 322, wherein of the cable 316 and the stabilisation elements 318, only the cross-sectional shapes are represented schematically and projected onto the base element 322. The centre point of the cross section of the cable 316 is arranged centrally on the base element 322. The stabilisation elements 318 are arranged to the side of the cable 316 on the base element 322.

One cable 316 is depicted here, wherein also two or more cables can be provided. Furthermore, only one stabilisation element or several further stabilisation elements can be provided.

Furthermore, the first guiding direction FR1 is depicted by way of example to clarify the direction in which elastic deformation of the first stabilisation device according to the third assembly is permitted. The rigid direction of the stabilisation elements 318 is formed perpendicular to the guiding direction FR1.

The third assembly can be advantageous if sufficient installation space in the direction of the guiding direction FR1 is available on the vehicle 70 or between the vehicle parts 72, 74.

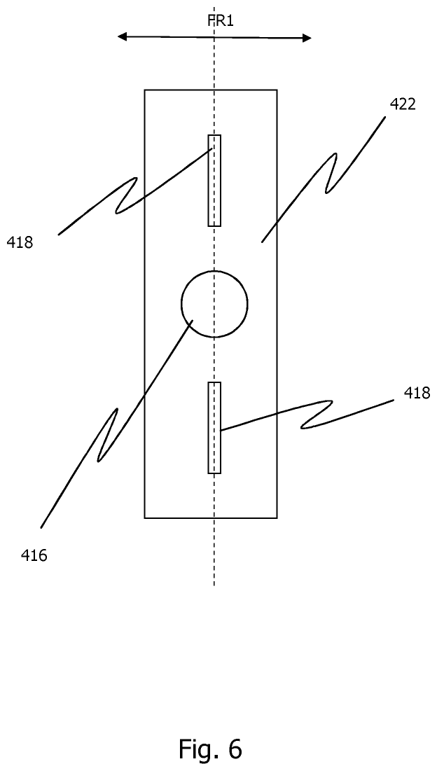

FIG. 6 shows a schematic representation of a fourth assembly of the stabilisation elements 418 and the cable 416 with regard to the base element 422, wherein of the cable 416 and the stabilisation elements 418, only the cross-sectional shapes are represented schematically and projected onto the base element 422. The centre point of the cross section of the cable 416 is arranged centrally on the base element 422. The centre points of the cross section of the cable 416 and of the stabilisation elements 418 lie on the common axis. The stabilisation elements 418 are arranged to the side of the cable 416 on the base element 422.

One cable 416 is depicted here, wherein also two or more cables can be provided. Furthermore, only one stabilisation element or several further stabilisation elements can be provided.

Furthermore, the first guiding direction FR1 is depicted by way of example to clarify the direction in which elastic deformation of the first stabilisation device according to the fourth assembly is permitted. The rigid direction of the stabilisation elements 418 is formed perpendicular to the guiding direction FR1.

The fourth assembly can be advantageous if sufficient installation space perpendicular to the guiding direction FR1 is available on the vehicle 70 or between the vehicle parts 72, 74.

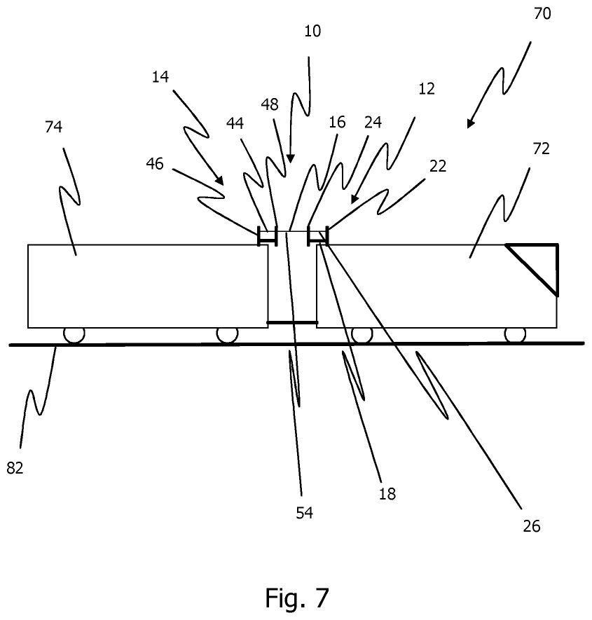

FIG. 7 shows a schematic representation of a vehicle 70 with a cable guide assembly 10. The vehicle 70 has the first vehicle part 72 and the second vehicle part 74. The vehicle 70 is a rail vehicle, which is arranged on rails 82.

The cable guide assembly 10 is mounted on an upper side of the vehicle 70, wherein this can be arranged, however, at another point also, for example in the space between the two vehicle parts 72, 74.

The cable guide assembly 10 is depicted in a simplified manner. It has the first stabilisation device 12, which is mounted on the first vehicle part 72, and the second stabilisation device, which is mounted on the second vehicle part 74. The free cable section 54 extends between the stabilisation devices 12, 14.

The first stabilisation device 12 has the associated base element 22, which is mounted fixedly on the first vehicle part 72, and the guide element 24, which is arranged in the space between the vehicle parts 72, 74 and is not directly connected to the first vehicle part 72. The first cable section 26 of the cable 16, and the single stabilisation element 18, extend between the guide element 24 and the base element 22. This is due to the exemplary representation; the respective stabilisation devices 12, 14 could also have other respective stabilisation elements.

In the first stabilisation device 12, the cable 16 or the first cable section 26 is arranged here above the stabilisation element 18. Furthermore, the cable guide assembly 10 here has the single cable 16, wherein several cables could also be provided.

The second stabilisation device 14 has the associated base element 46, which is mounted fixedly on the second vehicle part 74, and the guide element 48, which is arranged in the space between the vehicle parts 72, 74 and is not directly connected to the second vehicle part 74. The second cable section 44 of the cable 16, and the single stabilisation element 50, extend between the guide element 48 and the base element 46.

1. Cable guide assembly for a vehicle, in particular a rail vehicle, for guiding at least one cable from a first vehicle part to a second vehicle part, which is coupled in an articulated manner to the first vehicle part, having:
a first stabilisation device, which can be mounted on the first vehicle part; and
the at least one cable;
wherein the first stabilisation device is formed to be deformable in a first guiding direction and rigid perpendicular to this;
wherein the first stabilisation device is coupled to a first cable section of the cable in such a way that the deformability of the first stabilisation device permits movement of the first cable section in the first guiding direction and blocks it perpendicular thereto.

2. Cable guide assembly according to claim 1, wherein the stabilisation device has at least one stabilisation element, which determines the deformability of the stabilisation device.

3. Cable guide assembly according to claim 2, wherein the stabilisation element has a substantially rectangular cross section, wherein preferably the longer edge of the rectangular cross section is arranged perpendicular to the first and second guiding direction.

4. Cable guide assembly according to claim 2, wherein the stabilisation element comprises steel, in particular spring steel, plastic, a composite material, in particular carbon-fibre-reinforced plastic, or a combination thereof.

5. Cable guide assembly according to claim 1, wherein the first stabilisation device has a base element, which is provided to be connected fixedly to the respective vehicle part.

6. Cable guide assembly according to claim 1, wherein the first stabilisation device has a guide element, which is mounted by means of the respective stabilisation element on the base element.

7. Cable guide assembly according to claim 5, wherein the first cable section is arranged between the base element and the guide element of the first stabilisation device.

8. Cable guide assembly according to claim 1, wherein the first stabilisation device has at least one holding element, which supports the cable in the stabilisation device.

9. Cable guide assembly according to claim 8, wherein the holding element connects the cable fixedly to the stabilisation device.

10. Cable guide assembly according to claim 8, wherein the holding element permits movement of the cable relative to the stabilisation device in a longitudinal direction of the cable and/or rotation of the cable about a longitudinal direction of the cable relative to the stabilisation device.

11. Cable guide assembly according to claim 8, wherein the holding element has an interior region which supports the cable, wherein preferably an inner diameter of the interior region increases at least partially in at least one direction along the cable.

12. Cable guide assembly according to claim 8, wherein the first stabilisation device has a first such holding element, which supports the cable in its base element, and/or has a second such holding element, which supports the cable in its guide element.

13. Cable guide assembly according to claim 1, wherein a longitudinal axis of the first cable section is arranged substantially perpendicular to the first guiding direction.

14. Cable guide assembly according to claim 2, wherein a longitudinal axis of the stabilisation element of the first stabilisation device is arranged substantially perpendicular to the first guiding direction.

15. Cable guide assembly according to claim 1, wherein the cable is an electric cable or a media hose for guiding a medium, for example a hydraulic hose or a pneumatic hose.

16. Cable guide assembly according to claim 1, further comprising
a second stabilisation device, which can be mounted on the second vehicle part;
wherein the second stabilisation device is formed to be deformable in a second guiding direction and is formed rigid perpendicular to this;
wherein the second stabilisation device is coupled to a second cable section of the cable such that the deformability of the second stabilisation device permits movement of the second cable section in the second guiding direction and blocks it perpendicular thereto.

17. Cable guide assembly according to claim 16, wherein a free cable section of the cable links the first and the second stabilisation device to one another.

18. Vehicle, having
a first vehicle part,
a second vehicle part, which is coupled in an articulated manner to the first vehicle part, and
at least one cable guide assembly according to claim 1;
wherein the first stabilisation device is arranged on the first vehicle part, and
wherein the cable leads from the first vehicle part to the second vehicle part.

19. Vehicle, having
a first vehicle part,
a second vehicle part, which is coupled in an articulated manner to the first vehicle part, and
at least one cable guide assembly according to claim 16;
wherein the first stabilisation device is arranged on the first vehicle part and the second stabilisation device is arranged on the second vehicle part, and
wherein the cable leads from the first vehicle part to the second vehicle part.

20. Vehicle according to claim 18, wherein the first stabilisation device is arranged in such a way on the first vehicle part and the second stabilisation device is arranged in such a way on the second vehicle part that in a neutral position of the two vehicle parts relative to one another, a longitudinal axis of the first cable section encloses with a longitudinal axis of the second cable section an angle, preferably in the range of 45 to 135 degrees, particularly preferably of substantially 90 degrees.

21. Vehicle according to claim 18, wherein the vehicle parts are linked to one another rotatably about a rotation axis and the rotation axis is arranged substantially perpendicular to the first guiding direction and/or second guiding direction.
